(19) United States
(12) Patent Application Publication
(10) Pub. No.: US 2010/0272859 A1
(43) Pub. Date: Oct. 28, 2010

(54) DELIVERY AND CONTROLLED RELEASE OF ENCAPSULATED WATER-INSOLUBLE FLAVORANTS

(75) Inventor: Peter Given, Ridgefield, CT (US)

Correspondence Address: BANNER & WITCOFF, LTD.;and ATTORNEYS FOR CLIENT NO. 006943, 10 SOUTH WACKER DR., SUITE 3000, CHICAGO, IL, 60606, US

(73) Assignee: PepsiCo, Inc., Purchase, NY (US)

(21) Appl. No.: 11/846,236

(22) Filed: Aug. 28, 2007

(51) Int. Cl. A23L 1/22; A23C 13/16; A23C 19/00; A23C 9/123; A23F 3/00; A23L 1/48; A23L 2/38; C12H 1/14; A23L 2/56; A23L 2/02; A23L 1/39; A23F 5/00; A23L 1/00; A23L 1/0524

(52) U.S. Cl. 426/66; 426/102; 426/531; 426/577; 426/582; 426/583; 426/584; 426/589; 426/590; 426/592; 426/594; 426/597; 426/598; 426/599; 426/615; 426/89

(57) ABSTRACT

A complex coacervate delivery system is provided which encapsulates water-insoluble flavorants. The complex coacervate delivery system provides a stable dispersion of water-insoluble flavorant in an aqueous system, and also protects the flavorant from degradation, e.g., by oxidation or hydrolysis. The complex coacervate delivery system upon ingestion is operative to release at least a substantial portion of the flavorant in the mouth in a pH-controlled manner. The complex coacervate delivery system may be included in a food or beverage product having a pH value within the range of about 1.5 to about 5.0.

### FIELD OF THE INVENTION

The present invention relates to the field of delivering water-insoluble flavorants in an acidic aqueous system for controlled release to a consumer, more particularly encapsulated water-insoluble flavorants in acidic aqueous systems such as food and beverage products.

### BACKGROUND

Water-insoluble flavorants are typically incorporated directly into an aqueous system in one of four physical forms: a solution (with a compatible solvent), an extract, an emulsion, or a micellular dispersion (a so-called microemulsion). While all of these approaches serve to disperse the water-insoluble flavorant in an aqueous system, they do not provide any additional benefits such as, for example, controlled (triggered) release or extended protection against hydrolysis and oxidation.

Since a number of water-insoluble flavorants are sensitive to degradation by oxidation, hydrolysis or other mechanisms upon exposure to air, water, and/or light, it would be desirable to provide water-insoluble flavorants in a stable form for use in aqueous systems such as food and beverage products, so that the flavorant is stable to oxidation and hydrolysis during the shelf life of the food or beverage product. It would also be desirable to provide a composition which releases the flavorant in the mouth upon ingestion.

### BRIEF SUMMARY OF THE INVENTION

Aspects of the invention are directed to complex coacervate delivery systems comprising an aqueous dispersion of complex coacervates. The complex coacervates have a shell of at least one food-grade cationic polymer and at least one food-grade anionic polymer, and a core of at least one water-insoluble flavorant. The complex coacervate delivery system upon ingestion is operative to release at least a substantial portion of the water-insoluble flavorant in the mouth in a pH-controlled manner.

In certain exemplary embodiments, the complex coacervate delivery systems comprise an aqueous dispersion of substantially non-agglomerated complex coacervates. The complex coacervates have a substantially non-crosslinked, substantially non-gelled shell comprising whey protein isolate and pectin in a weight to weight ratio of about 1:3 and a core comprising a water-insoluble flavorant. The complex coacervates have a particle size of about 0.3 μm to about 0.5 μm. The complex coacervate delivery system has a pH value within the range of 2.8 to 4.0. The complex coacervate delivery system upon ingestion is operative to substantially release the flavorant in the mouth at a pH value within the range of pH 6.0 and above.

Other aspects of the invention are directed to aqueous dispersions of complex coacervates. The complex coacervates have a shell comprising at least one food-grade cationic polymer and at least one food-grade anionic polymer, and a core comprising at least one lipophilic water-insoluble flavorant. The aqueous dispersion of complex coacervates is operative to release at least a substantial portion of the water-insoluble flavorant in a pH-controlled manner.

Other aspects of the invention are directed to a beverage product which includes a complex coacervate delivery system comprising an aqueous dispersion of complex coacervates. The complex coacervates have a shell comprising at least one food-grade cationic polymer and at least one food-grade anionic polymer, and a core comprising at least one water-insoluble flavorant. Certain exemplary embodiments of the beverage product have a pH of about 1.5 to about 5.0. Upon ingestion of the beverage product, the complex coacervate delivery system is operative to release at least a substantial portion of the water-insoluble flavorant in the mouth in a pH-controlled manner.

Other aspects of the invention are directed to food products which include a complex coacervate delivery system comprising an aqueous dispersion of complex coacervates. The complex coacervates have a shell comprising at least one food-grade cationic polymer and at least one food-grade anionic polymer, and a core comprising at least one water-insoluble flavorant. The food product can have a pH of about 1.5 to about 5.0. Upon ingestion of the food product, complex coacervate delivery system is operative to release at least a substantial portion of the water-insoluble flavorant in the mouth in a pH-controlled manner.

These and other aspects, along with advantages and features of the present invention herein disclosed, will become apparent through reference to the following detailed description. Furthermore, it is to be understood that the features of the various embodiments described herein are not mutually exclusive and can exist in various combinations and permutations.

### DETAILED DESCRIPTION

Aspects of the invention relate to complex coacervate delivery systems which provide a stable dispersion of water-insoluble flavorant suitable for inclusion in food and beverage products, that is, the complex coacervates are stable for shelf-storage, for use in making foods and beverages, and for shelf-storage when included in acidic foods and beverages, etc. A reduction in the degradation, e.g., by oxidation or hydrolysis, of sensitive flavorants is achieved. The complex coacervate delivery system has the characteristic of being operative to release the flavorant in a pH-controlled manner, e.g. at near-neutral pH, or in the neutral conditions of the mouth where the pH of saliva can be about 6.0 to about 7.0. Various embodiments of the complex coacervate delivery system disclosed here may have the property of substantially releasing the flavorant at these and other near-neutral pH values, e.g., at any or at least one pH value between 6.0 and 8.0. As used herein, “pH-controlled release” (optionally referred to as release in a pH-controlled manner, or pH-dependent release, or pH-triggered release, or the like) means that the complex coacervates release at least a substantial portion of the encapsulated water-insoluble flavorant when the pH of the complex coacervate delivery system or the environment in which it is placed reaches or goes beyond a certain pH value, e.g., at any pH value within a specified range, or at one or more pH values within a specified range.

The complex coacervate delivery system may be incorporated into acidic food and beverage products such as, but not limited to, carbonated soft drinks and orange juice for example. By encapsulating such water-insoluble flavorants in a complex coacervate delivery system, possible negative hedonic, visual and physical changes to the food or beverage product may be reduced or avoided. The complex coacervate delivery system upon ingestion is operative to release in a pH-controlled manner a substantial portion of the encapsulated water-insoluble flavorant. As used herein, “substantial portion” means that the amount of flavorant released is enough to be detected by taste by a typical consumer, e.g. 1/10, ¼, ½, ¾, or 9/10 of the encapsulated flavorant. In certain exemplary embodiments, pH-controlled release of flavorant in the mouth can provide a consumer with a burst of flavor upon ingestion of the food or beverage product. Other exemplary embodiments may provide a more slowly emerging flavor. Other exemplary embodiments may enable lingering of a selected flavor over time. For example, a flavorant may advantageously be released primarily early in the taste profile, toward the end of the taste profile or in the middle of the taste profile. The resulting food or beverage product is appealing to the consumer, as well as being stable and having an adequate shelf life.

In certain exemplary embodiments, a complex coacervate delivery system is provided comprising an aqueous dispersion of complex coacervates. As used herein, a “delivery system” is a composition or a mixture of components which can be used to carry the complex coacervates encapsulating the water-insoluble flavorant and to provide or deliver them into a system or environment or the like, e.g. into a food or beverage intended for consumption by humans or animals. As used herein, an “aqueous dispersion” is defined as particles distributed throughout a medium of liquid water, e.g., as a suspension, a colloid, an emulsion, a sol, etc. As used herein, a “complex coacervate” is a particle having a shell comprising at least two oppositely charged polymers (that is, cationic polymers of at least one type and anionic polymers of at least one type) which substantially encapsulates a core material. As used herein, polymers include not only traditional polymers, but also oligomers and the like. At least a majority of the complex coacervates have a particle size within the range of about 0.1 to about 5.0 μm, preferably within the range of about 0.3 to about 2.0 μm, most preferably within the range of about 0.3 to about 0.5 μm. The particle sizes disclosed here include any or at least one value within the disclosed ranges as well as the endpoints of the ranges. Preferably the complex coacervates disclosed here have a negative zeta potential, that is, the outside of the complex coacervate shell displays a net negative charge. Preferably, the complex coacervates are substantially non-agglomerated, but comprise a single shell encapsulating a single core. The core includes at least one water-insoluble flavorant, for example a liquid such as an oil. As used herein, a “water-insoluble flavorant” is any substance that provides a desired flavor to a food or beverage product, which does not substantially dissolve in water (e.g., non-polar, hydrophobic substances such as lipids, fats, oils, etc.). The shell includes a net positive charged (cationic) polymer and a net negative charged (anionic) polymer. It is believed that the net charge of each polymer is dependent on the pH of the environment and the isoelectric point of each polymer, which is in turn dependent on the density of ionizable groups in each polymer and the pKa values of those groups. Thus, disclosure here of complex coacervates comprising cationic and anionic polymers refers to the charge of the polymers in the environment or reaction conditions used for formation of the complex coacervates. Complex coacervates of the type used here are presently understood to be stabilized at least in part by the electrostatic attraction between the oppositely charged polymers, and thus are selected or designed to release upon a particular physiological trigger, specifically a pH change. In certain exemplary embodiments, the complex coacervates are not substantially additionally stabilized, for example by substantial gelling, substantial crosslinking, or substantial hardening of the complex coacervate shell. Gelling, crosslinking, and hardening are believed to hinder the rate of pH-controlled dissociation of the complex coacervates and the resulting release of water-insoluble flavorants.

Exemplary polymers for use in the complex coacervates delivery systems disclosed here include oppositely charged food-grade biopolymers that form complex coacervates at an acidic pH, e.g., a pH value below about pH 6.0, in certain exemplary embodiments, a pH value within the range of about 1.5 to about 5.0, in certain exemplary embodiments, a pH value within the range of about 2.8 to about 4.0. The complex coacervates disclosed here are stable at an acidic pH, e.g., a pH value within the range below about pH 6.0, in certain exemplary embodiments, a pH value within the range of about 1.5 to about 5.0, in certain exemplary embodiments, a pH value within the range of about 2.8 to about 4.0. In certain exemplary embodiments, the complex coacervates are stable at a pH within such recited ranges in the sense that they are stable at any pH value within the recited range, including the endpoints. In other exemplary embodiments, the complex coacervates are stable at one or more pH values within the recited range, including the endpoints, but are not stable at every pH value within the recited range. As used herein, “stable” means that at least a majority of the complex coacervates do not dissociate and release the water-insoluble flavorants. As used herein, “food-grade” is defined as any material that is deemed by the U.S. Food and Drug Administration or the Flavor Extracts Manufacturing Association to be safe for use in food and beverage products. Exemplary cationic polymers include but are not limited to proteins such as dairy proteins, including whey proteins, caseins and fractions thereof, gelatin, corn zein protein, bovine serum albumin, egg albumin, grain protein extracts, e.g. protein from wheat, barley, rye, oats, etc., vegetable proteins, microbial proteins, chitosan, legume proteins, proteins from tree nuts, proteins from ground nuts, and the like. Exemplary anionic polymers include but are not limited to polysaccharides such as pectin, carrageenan, alginate, xanthan gum, modified celluloses, e.g., carboxymethylcellulose, gum acacia, gum ghatti, gum karaya, gum tragacanth, locust bean gum, guar gum, psyllium seed gum, quince seed gum, larch gum (arabinogalactans), stractan gum, agar, furcellaran, modified starches, gellan gum, fucoidan, and the like. An exemplary complex coacervate shell comprises whey protein isolate and pectin. There are many possible combinations of oppositely charged, food-grade biopolymers that are useful for forming the complex coacervates disclosed here. The weight to weight ratio of cationic polymer to anionic polymer can be from about 16:1 to about 1:20. In certain exemplary embodiments, the weight to weight ratio of cationic polymer to anionic polymer is from about 6:1 to about 1:6, and is preferably about 1:3.

When included in an acidic food or beverage product, e.g. a food or beverage product having a pH value within the range below about 6.0, in certain exemplary embodiments, a pH value within the range of about 1.5 to about 5.0, or in certain exemplary embodiments, a pH value within the range of about 2.8 to about 4.0, the complex coacervate delivery systems disclosed here provide a stable dispersion of encapsulated water-insoluble flavorant. Upon ingestion of the food or beverage product, that is, upon being consumed by a human or animal, at least a substantial portion of the complex coacervates in the complex coacervate delivery systems dissociate and release the water-insoluble flavorant in the mouth when contacted with saliva which can have a pH of about 6.0 to about 7.0. It is believed that neutral to basic conditions (e.g. at pH values of about 6.0 and above) trigger dissociation of the complex coacervates and release of the water-insoluble flavorant due to weakening of the electrostatic forces that stabilize the complex coacervate shell. In addition, it is contemplated that complex coacervate delivery systems according to aspects of the present invention will exhibit additional desired physical properties. For example, it is contemplated that complex coacervate delivery systems will have an acceptable mouthfeel, taste, aroma, and appearance.

In certain exemplary embodiments, water-insoluble flavorants may include any one or more food-grade flavorants that do not substantially dissolve in water. The flavorant may be a liquid, gel, colloid, or particulate solid, e.g., an oil, an extract, an oleoresin, or the like. Exemplary water-insoluble flavorants may include but are not limited to citrus oils and extracts, e.g. orange oil, lemon oil, grapefruit oil, lime oil, citral and limonene, nut oils and extracts, e.g. almond oil, hazelnut oil and peanut oil, other fruit oils and extracts, e.g. cherry oil, apple oil and strawberry oil, botanical oils and extracts, e.g., coffee oil, mint oil, vanilla oil, and combinations thereof.

In certain exemplary embodiments, a desired amount of water-insoluble flavorant in the form of the above-described complex coacervate delivery system is included in a food or beverage product. The amount of complex coacervate delivery system, and hence the amount of water-insoluble flavorant included in the food or beverage product may vary depending on the application and desired taste characteristics of the food or beverage product. The complex coacervate delivery system may be added to the food or beverage product in any number of ways, as would be appreciated by those of ordinary skill in the art given the benefit of this disclosure. In certain exemplary embodiments, the complex coacervate delivery system is sufficiently mixed in the food or beverage product to provide a substantially uniform distribution, for example a stable dispersion. Mixing should be accomplished such that the complex coacervates are not destroyed. If the complex coacervates are destroyed, premature release (exposure) of flavor and oxidation or hydrolysis of the water-insoluble flavorant may result. The mixer(s) can be selected for a specific application based, at least in part, on the type and amount of ingredients used, the viscosity of the ingredients used, the amount of product to be produced, the flow rate, and the sensitivity of ingredients, such as the complex coacervate delivery system, to shear forces.

Encapsulation of water-insoluble flavorants using the above-described complex coacervate delivery system stabilizes the water-insoluble flavorant by protecting it from degradation by, for example, oxidation and hydrolysis. When included in an acidic food or beverage product, the complex coacervate delivery system can provide a stable dispersion of water-insoluble flavorant over the shelf-life of the food or beverage product. In certain exemplary embodiments, the finished food or beverage product including complex coacervate delivery systems as disclosed here have a shelf-life greater than one week, e.g., about 1-12 months and possibly up to 24 months or longer under ambient conditions, (e.g., room temperature of between 70° F. and 80° F. and controlled light exposure), depending on the level of processing the product undergoes, the type of packaging, and the materials used for packaging the product. In other embodiments, the finished product with the complex coacervate delivery system may have a shelf-life of about 12 weeks up to about 20 weeks under refrigerated conditions. In other embodiments, the finished product may be stored indefinitely under frozen conditions. Additional factors that may affect the shelf-life of the product include, for example, the nature of the base formula (e.g., an acidic beverage sweetened with sugar has a longer shelf-life than an acidic beverage sweetened with aspartame) and environmental conditions (e.g., exposure to high temperatures and sunlight is deleterious to ready-to-drink beverages).

In certain exemplary embodiments, the beverage products disclosed here are ready-to-drink beverages, beverage concentrates, syrups, shelf-stable beverages, refrigerated beverages, frozen beverages, and the like. Preferably, the beverage product is acidic, e.g. having a pH within the range below about 6.0, in certain exemplary embodiments, a pH value within the range of about 1.5 to about 5.0, or in certain exemplary embodiments, a pH value within the range of about 2.8 to about 4.0. Beverage products include, e.g., carbonated and non-carbonated beverages, fountain beverages, liquid concentrates, fruit juice and fruit juice-flavored drinks, sports drinks, energy drinks, fortified/enhanced water drinks, soy drinks, vegetable drinks, grain-based drinks (e.g. malt beverages), fermented drinks (e.g., yogurt and kefir) coffee drinks, tea drinks, dairy beverages, and mixtures thereof. Exemplary fruit juice sources include citrus fruit, e.g. orange, grapefruit, lemon and lime, berry, e.g. cranberry, raspberry, blueberry and strawberry, apple, grape, pineapple, prune, pear, peach, cherry, mango, and pomegranate. Beverage products include bottle, can, and carton products and fountain syrup applications.

Certain exemplary embodiments of the food products disclosed here include fermented food products, yogurt, sour cream, cheese, salsa, ranch dip, fruit sauces, fruit jellies, fruit jams, fruit preserves, and the like. Preferably, the food product is acidic, e.g. having a pH value within the range below about pH 6.0, in certain exemplary embodiments, a pH value within the range of about 1.5 to about 5.0, or in certain exemplary embodiments, a pH value within the range of about 2.8 to about 4.0. All variations, alternatives, options, etc., discussed elsewhere in this disclosure apply to food embodiments of the invention, for example, any complex coacervate comprising any cationic or anionic polymer in any ratio, any water-insoluble flavorant, and any particle size can be used in food embodiments in any combination suitable for application to food products.

The food or beverage product may optionally include other additional ingredients. Additional ingredients may include, for example, vitamins, minerals, sweeteners, water-soluble flavorants, colorings, thickeners, emulsifiers, acidulants, electrolytes, antifoaming agents, proteins, carbohydrates, preservatives, water-miscible flavorants, edible particulates, and mixtures thereof. Other ingredients are also contemplated. The ingredients can be added at various points during processing, including before or after pasteurization, and before or after addition of the complex coacervate delivery system.

Food and beverage products may be pasteurized. The pasteurization process may include, for example, ultra high temperature (UHT) treatment and/or high temperature-short time (HTST) treatment. The UHT treatment includes subjecting the food or beverage product to high temperatures, such as by direct steam injection or steam infusion, or by indirect heating in a heat exchanger. Generally, after the product is pasteurized, the product can be cooled as required by the particular product composition/configuration and/or the package filling application. For example, in one embodiment, the food or beverage product is subjected to heating to about 185° F. (85° C.) to about 250° F. (121° C.) for a short period of time, for example, about 1 to 60 seconds, then cooled quickly to about 36° F. (2.2° C.)+/10° F. (5° C.) for refrigerated products, to ambient temperature for shelf stable or refrigerated products, and to about 185° F. (85° C.)+/−10° F. (5° C.) for hot-fill applications for shelf-stable products. The pasteurization process is typically conducted in a closed system, so as not to expose the food or beverage product to atmosphere or other possible sources of contamination. Other pasteurization or sterilization techniques may also be useful, such as, for example, aseptic or retort processing. In addition, multiple pasteurization processes may be carried out in series or parallel, as necessitated by the food or beverage product or ingredients.

Food and beverage products may, in addition, be post processed. Post processing is typically carried out following addition of the complex coacervate delivery system. Post processing can include, for example, cooling the product solution and filling it into container for packaging and shipping. Post processing may also include deaeration of the food product to <4.0 ppm oxygen, preferably <2.0 ppm and more preferably <1.0 ppm oxygen. Deaeration, however, and other post processing tasks may be carried out prior to processing, prior to pasteurization, prior to mixing with the complex coacervate delivery system and/or at the same time as adding the complex coacervate delivery system. In addition, an inert gas (e.g., nitrogen or argon) headspace may be maintained during the intermediary processing of the product and final packaging. Additionally/alternatively, an oxygen or UV radiation barriers and/or oxygen scavengers could be used in the final packaging.

### EXAMPLES

The following examples are specific embodiments of the present invention but are not intended to limit it.

### Example 1

A complex coacervate delivery system in accordance with one exemplary embodiment of the disclosure was prepared using the following method. The components below can be added to the mixing or blending vessel in any order without substantially impacting the resulting complex coacervate delivery system. One of many possible random orders of addition is described below. A 0.4% aqueous solution of whey protein isolate (0.6 g for a final volume of 150 mL) was prepared. A 50/50 by weight blend of citral and medium chain triglycerides was added to a 10% load (15 g/150 mL final volume). A 1.2% aqueous solution of high methoxy pectin was added (1.8 g/150 mL final volume). Citric acid was added to a 0.1% load (0.15 g/150 mL final volume). High shear mixing was applied for 2 minutes using a Silverson rotor-stator type mixer. Then homogenization at 4000 psi was applied for one pass. Optionally, an additional mixing and homogenization step can be performed after the random addition of any two components. This procedure results in the formation of coacervate complexes of cationic whey protein isolate and anionic pectin which encapsulate droplets of citral blend. Particle size of the complex coacervates is about 0.3 to about 0.5 μm. Final pH of the complex coacervate delivery system is about 3.3 to about 3.6.

### Example 2

A complex coacervate delivery system was prepared in the same way as in Example 1, except by replacing the pectin solution with a 0.6% aqueous solution of lambda-carrageenan (0.9 g/150 mL final volume).

### Example 3

A complex coacervate delivery system was prepared in the same way as Example 1, except by replacing the pectin solution with a 0.025% aqueous solution of sodium alginate (0.0375 g/150 mL final volume).

### Example 4

A complex coacervate delivery system was prepared in the same way as Example 1, except by replacing the pectin solution with a 0.6% aqueous solution of kappa-carrageenan (0.9 g/150 mL final volume).

### Example 5

A complex coacervate delivery system was prepared in the same way as in Example 1, except by replacing the pectin solution with a 0.6% aqueous solution of xanthan gum (0.9 g/150 mL final volume).

### Example 6

A complex coacervate delivery system was prepared in the same way as Example 1, except by replacing the citral blend with weighted orange oil (a 50/50 by weight blend of orange oil and ester gum) to a load of 10% (15 g/150 mL final volume).

### Example 7

A complex coacervate delivery system was prepared in the same way as Example 1, except by replacing the citral blend with lemon oil (unweighted) to a load of 10% (15 g/150 mL final volume).

### Example 8

The storage stability of the described complex coacervates was tested. Complex coacervates of whey protein isolate and pectin were found to have superior particle size stability (e.g., particles remained in dispersion and did not coalesce, agglomerate, or burst over time) under both ambient conditions (70° F. for 30 days) or under accelerated conditions (110° F. for 8 days). The graph below shows the particle size stability of the complex coacerverate delivery systems described in Examples 1 and 2. As illustrated below, the particle size of the complex coacervate delivery system comprising whey protein isolate and pectin remains below 0.5 μm for at least 17 days, and continues to be stable for greater than one month.

The invention has been described with reference to the preferred embodiments. Obviously, modifications and alterations will occur to others upon reading and understanding the preceding detailed description. It is intended that the invention be construed as including all such modifications and alterations insofar as they come within the scope of the appended claims or the equivalents thereof.

What is claimed is:

1. A complex coacervate delivery system comprising an aqueous dispersion of complex coacervates;
wherein the complex coacervates comprise
a shell comprising at least one food-grade cationic polymer and at least one food-grade anionic polymer; and
a core comprising at least one water-insoluble flavorant;
wherein upon ingestion, the complex coacervate delivery system is operative to release at least a substantial portion of the flavorant in the mouth in a pH-dependent manner.

2. The complex coacervate delivery system of claim 1, having a pH value within the range of 1.5 and 5.0.

3. The complex coacervate delivery system of claim 1, having a pH value within the range of 2.8 and 4.0.

4. The complex coacervate delivery system of claim 1, wherein the complex coacervate delivery system is operative to release a substantial portion of the flavorant in the mouth at a pH value within the range of pH 6.0 and above.

5. The complex coacervate delivery system of claim 1, wherein the complex coacervate delivery system is operative to release a substantial portion of the flavorant in the mouth at any pH value within the range of pH 6.0 and above.

6. The complex coacervate delivery system of claim 1, wherein the complex coacervate delivery system is operative to release a substantial portion of the flavorant in the mouth at one or more pH values within the range of pH 6.0 and above.

7. The complex coacervate delivery system of claim 1, wherein the water-insoluble flavorant comprises at least one of citral, limonene, and extract or oil of orange, lemon, lime, grapefruit, almond, hazelnut, peanut, cherry, apple, strawberry, coffee, mint, and vanilla.

8. The complex coacervate delivery system of claim 1, wherein the complex coacervates have a negative zeta potential.

9. The complex coacervate delivery system of claim 1, wherein at least a majority of the complex coacervates have a particle size within the range of 0.1 to 5.0 μm.

10. The complex coacervate delivery system of claim 1, wherein at least a majority of the complex coacervates have a particle size within the range of 0.3 to 2.0 μm.

11. The complex coacervate delivery system of claim 1, wherein at least a majority of the complex coacervates have a particle size within the range of 0.3 to 0.5 μm.

12. The complex coacervate delivery system of claim 1, wherein the cationic polymer comprises at least one of dairy proteins, whey proteins, caseins and fractions thereof, gelatin, corn zein protein, bovine serum albumin, egg albumin, grain protein extracts, vegetable proteins, microbial proteins, chitosan, legume proteins, proteins from tree nuts, and proteins from ground nuts.

13. The complex coacervate delivery system of claim 1, wherein the anionic polymer comprises at least one of pectin, carrageenan, alginate, xanthan gum, modified celluloses, carboxymethylcellulose, gum acacia, gum ghatti, gum karaya, gum tragacanth, locust bean gum, guar gum, psyllium seed gum, quince seed gum, larch gum (arabinogalactans), stractan gum, agar, furcellaran, modified starches, and gellan gum.

14. The complex coacervate delivery system of claim 1, wherein the cationic polymer comprises whey protein isolate and the anionic polymer comprises pectin.

15. The complex coacervate delivery system of claim 1, wherein the weight to weight ratio of cationic polymer to anionic polymer is from 16:1 to 1:20.

16. The complex coacervate delivery system of claim 1, wherein the weight to weight ratio of cationic polymer to anionic polymer is from 6:1 to 1:6.

17. The complex coacervate delivery system of claim 1, wherein the weight to weight ratio of cationic polymer to anionic polymer is about 1:3.

18. The complex coacervate delivery system of claim 1, wherein the shell is substantially non-crosslinked.

19. The complex coacervate delivery system of claim 1, wherein the shell is substantially non-gelled.

20. The complex coacervate delivery system of claim 1, wherein the complex coacervates are substantially non-agglomerated.

21. A complex coacervate delivery system comprising an aqueous dispersion of substantially non-agglomerated complex coacervates, comprising:
a substantially non-crosslinked, substantially non-gelled shell comprising whey protein isolate and pectin in a weight to weight ratio of about 1:3; and
a core comprising at least one water-insoluble flavorant;
wherein at least a majority of the complex coacervates have a particle size within the range of 0.3 to 0.5 μm;
wherein the complex coacervate delivery system has a pH value within the range of 2.8 and 4.0;
wherein the complex coacervate delivery system upon ingestion is operative to release a substantial portion of the flavorant in the mouth at a pH value within the range of pH 6.0 and above.

22. An aqueous dispersion of complex coacervates, wherein the complex coacervates comprise:
a shell comprising at least one food-grade cationic polymer and at least one food-grade anionic polymer; and
a core comprising at least one water-insoluble flavorant;
wherein the aqueous dispersion of complex coacervates is operative to release at least a substantial portion of the water-insoluble flavorant in a pH-controlled manner.

23. A beverage product comprising a complex coacervate delivery system comprising an aqueous dispersion of complex coacervates, wherein the complex coacervates comprise:
a shell comprising at least one food-grade cationic polymer and at least one food-grade anionic polymer, and
a core comprising at least one water-insoluble flavorant;
wherein the beverage product has a pH value within the range of 1.5 to 5.0; and
wherein upon ingestion of the beverage product, the complex coacervate delivery system is operative to release at least a substantial portion of the flavorant in the mouth in a pH-controlled manner.

24. The beverage product of claim 23, wherein the beverage product comprises a ready-to-drink beverage.

25. The beverage product of claim 23, wherein the beverage product is selected from the group consisting of carbonated beverages, non-carbonated beverages, fountain beverages, liquid concentrates, fruit juices, fruit juice-flavored drinks, sports drinks, energy drinks, fortified/enhanced water drinks, soy drinks, vegetable drinks, grain-based drinks, malt beverages, fermented drinks, yogurt drinks, kefir, coffee beverage, tea beverages, dairy beverages, and mixtures thereof.

26. The beverage product of claim 23, wherein upon ingestion of the beverage product, the complex coacervate delivery system is operative to release at least a substantial portion of the flavorant in the mouth at a pH value within the range of pH 6.0 and above.

27. The beverage product of claim 23, wherein upon ingestion of the beverage product, the flavorant is substantially released early in the taste profile.

28. The beverage product of claim 23, wherein upon ingestion of the beverage product, the flavorant is substantially released toward the end of the taste profile.

29. The beverage product of claim 23, wherein upon ingestion of the beverage product, the flavorant is substantially released in the middle of the taste profile.

30. A food product comprising a complex coacervate delivery system comprising an aqueous dispersion of complex coacervates, wherein the complex coacervates comprise:
a shell comprising at least one food-grade cationic polymer and at least one food-grade anionic polymer, and
a core comprising at least one water-insoluble flavorant;
wherein the food product has a pH value within the range of 1.5 to 5.0; and
wherein upon ingestion of the food product, the complex coacervate delivery system is operative to release at least a substantial portion of the flavorant in the mouth in a pH-controlled manner.

31. The food product of claim 30, wherein the food product is selected from the group consisting of fermented food products, yogurt, sour cream, cheese, salsa, ranch dip, fruit sauces, fruit jellies, fruit jams, fruit preserves.

32. The food product of claim 30, wherein upon ingestion of the food product, the complex coacervate delivery system is operative to release at least a substantial portion of the flavorant in the mouth at a pH value within the range of pH 6.0 and above.
